(19) United States
(12) Patent Application Publication
(10) Pub. No.: US 2024/0288933 A1
(43) Pub. Date: Aug. 29, 2024

(54) METHOD, APPARATUS, DEVICE AND MEDIUM FOR INTERACTING IN A VIRTUAL SCENE

(71) Applicant: Beijing Zitiao Network Technology Co., Ltd., Beijing (CN)

(72) Inventor: Xindu MA, Beijing (CN)

(21) Appl. No.: 18/586,272

(22) Filed: Feb. 23, 2024

(30) Foreign Application Priority Data
Feb. 24, 2023 (CN) 202310189772.3

(51) Int. Cl. G06F 3/01; G06F 3/04815

(52) U.S. Cl. CPC G06F 3/011; G06F 3/017; G06F 3/04815

(57) ABSTRACT

According to embodiments of the disclosure, a method, apparatus, device, and storage medium for interacting in a virtual scene are provided. The method includes determining an interaction mode associated with a virtual scene. In response to detecting a predetermined gesture associated with a virtual avatar in the virtual scene, a set of controls associated with the virtual scene is presented in proximity to a hand of the virtual avatar, and the set of controls is determined at least based on the interaction mode. Therefore, the set of controls may be configured in accordance with the interaction mode of the virtual scene, thereby improving the usability of the provided controls, reducing the difficulty and consumption of selecting controls from the set of controls, and improving user experience.

### CROSS REFERENCE

The present application claims priority to Chinese Patent Application No. 202310189772.3, filed on Feb. 24, 2023 and entitled “Method, apparatus, device and computer readable medium for interacting in a virtual scene”, the entirety of which is incorporated herein by reference.

### FIELD

Example embodiments of the present disclosure generally relate to the field of computer, and more particularly to a method, apparatus, device and computer readable medium for interacting in a virtual scene.

### BACKGROUND

Extended Reality (referred to as XR) has been widely studied and applied. XR integrates virtual content and real scenes through the combination of hardware devices and various technical means, providing users with unique sensory experiences. For example, XR includes virtual reality (referred to as VR), augmented reality (referred to as AR), mixed reality (referred to as MR), etc. VR simulates a virtual world in three-dimensional space using a computer, providing users with immersive experiences in visual, auditory, tactile and other aspects. AR allows real environments and virtual objects to be superimposed in the same space in real time and coexist simultaneously. MR is a new visual environment that integrates the real world and virtual world, where objects in the physical real-world scene coexist in real time with objects in the virtual world.

Therefore, virtual scenes may be used to provide users with an immersive interactive experience.

### SUMMARY

In a first aspect of the present disclosure, there is provided a method of interacting in a virtual scene. The method includes: determining an interaction mode associated with a virtual scene; and in response to detecting a predetermined gesture associated with a virtual avatar in the virtual scene, presenting a set of controls associated with the virtual scene in proximity to a hand of the virtual avatar, the set of controls being determined at least based on the interaction mode.

In a second aspect of the present disclosure, there is provided an apparatus for interacting in a virtual scene. The apparatus includes: a mode determining unit configured for determining an interaction mode associated with a virtual scene; and a control presenting unit configured for, in response to detecting a predetermined gesture associated with a virtual avatar in the virtual scene, presenting a set of controls associated with the virtual scene in proximity to a hand of the virtual avatar, the set of controls being determined at least based on the interaction mode.

In a third aspect of the present disclosure, there is provided an electronic device. The device includes at least one processing unit; and at least one memory, the at least one memory being coupled to the at least one processing unit and storing an instruction for execution by the at least one processing unit. The instructions cause the device to perform the method of the first aspect when executed by at least one processing unit.

In a fourth aspect of the present disclosure, there is provided a computer-readable storage medium. The computer-readable storage medium stores a computer program that may be executed by a processor to implement the method of the first aspect.

It should be understood that the contents described in the summary section are not intended to limit the key features or important features of the embodiments of the present disclosure, nor are they intended to limit the scope of the present disclosure. Other features of the present disclosure will become readily understood from the following description.

### BRIEF DESCRIPTION OF THE DRAWINGS

The above and other features, advantages and aspects of the various embodiments of the present disclosure will become more apparent in conjunction with the accompanying drawings and with reference to the following detailed description. In the drawings, same or similar reference numerals denote same or similar elements, where:

FIG. 1 shows a schematic diagram of an example environment in which embodiments of the present disclosure may be implemented;

FIG. 2 shows a flowchart of a process of interaction in a virtual scene according to some embodiments of the present disclosure;

FIGS. 3A, 3B, 3C show a schematic diagram of an example of a virtual meeting scene according to some embodiments of the present disclosure;

FIG. 4 shows a schematic diagram of an example of activating a target control in a virtual meeting scene according to some embodiments of the present disclosure;

FIG. 5 shows a schematic diagram of an example of the function is activated according to some embodiments of the present disclosure;

FIG. 6 shows a schematic diagram of a presentation example of different users in a virtual meeting scene according to some embodiments of the present disclosure;

FIG. 7 shows a schematic diagram of an example of meeting mode switch according to some embodiments of the present disclosure;

FIG. 8 shows a block diagram of an apparatus for interacting in a virtual meeting scene according to some embodiments of the present disclosure; and

FIG. 9 shows a block diagram of a device capable of implementing a plurality of embodiments of the present disclosure.

### DETAILED DESCRIPTION

It can be understood that the user is informed of a type, an application range and an application scene of personal information in an appropriate manner, to obtain permission from the user before the technical solution according to the embodiments of the present disclosure is used.

For example, prompt information is sent to the user in response to a reception of an active request from the user, to explicitly inform the user that the requested operation may acquire and use personal information of the user. Therefore, the user may voluntarily choose whether to provide the personal information to software or hardware, such as an electronic device, an application, a server, or a storage medium, with which an operation is performed according to the technical solutions of the present disclosure.

As an optional but non-restrictive implementation, the prompt information is sent to the user with a pop-up window, in response to the reception of the active request from the user. The prompt information may be presented as a text in the pop-up window. In addition, a selection control may be carried in the pop-up window, by which the user may select “agree” or “disagree” to provide personal information to the electronic device.

It can be understood that the above processes of informing the user and acquiring permission from the user is only illustrative, and the implementation of the present disclosure is not limited thereto. Other implementations that conform to the relevant laws and regulations may also be applied to the present disclosure.

It can be understood that the data involved in this technical solution (including but not limited to the data itself, data acquisition or use) should comply with the requirements of relevant laws and regulations and relevant provisions.

The following will describe embodiments of the present disclosure in more detail with reference to the accompanying drawings. Although certain embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the accompanying drawings and embodiments of the present disclosure are for illustrative purposes only and are not intended to limit the scope of protection of the present disclosure.

It should be noted that the titles of any section/sub-section provided herein are not restrictive. Various embodiments are described herein, and any type of embodiment can be included under any section/sub-section. In addition, the embodiments described in any section/sub-section can be combined in any way with any other embodiments described in the same section/sub-section and/or different sections/sub-sections.

In the description of embodiments of the present disclosure, the term “include” and similar terms should be understood as open-ended inclusion, that is, “include but not limited to”. The term “based on” should be understood as “at least partially based on”. The term “one embodiment” or “the embodiment” should be understood as “at least one embodiment”. The term “some embodiments” should be understood as “at least some embodiments”. The following text may also include other explicit and implicit definitions. The terms “first”, “second”, etc. may refer to different or identical objects. The following text may also include other explicit and implicit definitions.

As briefly mentioned earlier, the virtual scene generation device may generate virtual scenes according to requirements, such as virtual meeting room, virtual live stream, etc. For example, if the virtual scene is a virtual meeting scene, the virtual scene generation device may generate a virtual avatar of a user after the user connects to the virtual meeting scene. In this case, the user may interact with the virtual avatars of other users in the virtual meeting scene through the virtual avatar, achieving an immersive meeting experience.

In this case, in order to provide users with a better interactive experience, at least one control is usually predetermined in the virtual scene, and the control can be used to activate the corresponding function. Usually, such functions are associated with the implemented virtual scene. For example, in a case where the virtual scene is a virtual meeting scene, such functions are brushes, notes, memos, etc. Users may activate the corresponding functions by triggering the control in the virtual meeting scene. For example, after the user triggers the control corresponding to the brush function, the brush function is activated for the user in the virtual meeting scene, so that the user may use the brush function to write, draw, and the like in the virtual meeting scene.

Correspondingly, a feasible configuration method is to group the controls of each function that can be provided in the virtual scene into a set of controls and present them to the user in the virtual scene. The user may scroll through the set of controls to select and activate the controls through gesture operations.

However, as the number of functions that can be provided in the virtual scene increases, the number of controls in a set of controls will correspondingly increase. In this case, this configuration method will increase the difficulty and consumption for users to select controls from a set of controls, thereby affecting user experience.

Embodiments of the present disclosure provide a solution for interacting in a virtual scene. According to various embodiments of the present disclosure, an interaction mode associated with a virtual scene is determined. And in response to detecting a predetermined gesture associated with a virtual avatar in the virtual scene, a set of controls associated with the virtual scene is presented in proximity to a hand of the virtual avatar, the set of controls is determined at least based on the interaction mode. Therefore, by using embodiments of the present disclosure, a set of controls associated with the interaction mode of the virtual scene may be configured to improve the usability of the set of controls, reduce the difficulty and consumption of selecting controls from a set of controls, and improve the user experience.

### Example Environment

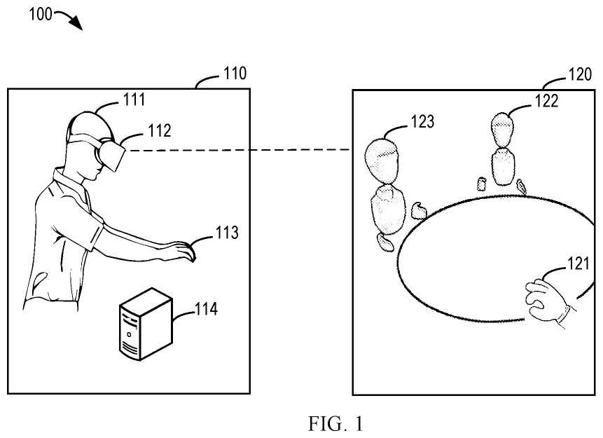

FIG. 1 shows a schematic diagram of an example environment 100 in which embodiments of the present disclosure may be implemented. In the environment 100, a physical scene 110 and a virtual scene (such as a virtual meeting scene 120) are included, and the physical scene 110 is an actual scene example of the real world. The physical scene 110 includes a user 111, an XR device 112, and an electronic device 114. The electronic device 114 is communicatively connected to the XR device 112, and the electronic device 112 is used to generate a virtual meeting scene 120 and communicate with the XR device 112. The user 111 may use the XR device 112 to join the virtual meeting scene 120. It should be understood that such a virtual meeting scene 120 is merely an example of a virtual scene. In some embodiments, such a virtual scene may be, for example, a virtual meeting room scene, a virtual live stream scene, etc. as described above.

The virtual meeting scene 120 may include a hand 121 of the virtual avatar of the user 111 and the virtual avatars 122 and 123 of other users participating in the virtual meeting scene. Specifically, the virtual avatar is presented to the user in the virtual meeting scene for indicating the user in the virtual meeting scene. For example, the virtual avatar 122 is used to indicate a first other user participating in the virtual meeting, and the virtual avatar 123 is used to indicate a second other user participating in the virtual meeting. The user 111 may interact with the first other user by watching the actions and messages made by the virtual avatar 122 in the virtual meeting scene 120.

The electronic device 114 may be a separate device capable of communicating with the XR device 112 and/or other image capture devices, such as a server for image or data processing, a computing node, etc., or may be integrated with the XR device 112 and/or other image capture devices. In some embodiments, the electronic device 115 may be implemented as the XR device 112, that is, in this case, the XR device 112 may implement all the functions of the electronic device 114. It should be understood that the foregoing description of the electronic device 114 is merely an example and not limiting, and the electronic device 114 may be implemented as a variety of forms, structures, or classes of devices, embodiments of the present disclosure are not limiting thereto.

An example is given in which the XR device 112 can realize all the functions of the electronic device 115. In the physical scene 110, the XR device 112 determines the action (e.g., gesture) performed by the object 113 (e.g., hand) of the user 111 by continuously capturing images of the object 113 (e.g., hand) of the user 111. The XR device 112 may continuously adjust the presentation style of the virtual avatar (only partially showing the hand 121 of the virtual avatar) corresponding to the user 111 in the virtual meeting scene according to the action and manipulate the virtual avatar to perform the corresponding action. For example, in a case where the XR device detects that the user 111 uses the object 113 (e.g., hand) to perform an action (e.g., changing from five fingers open to at least two fingers pinched), the XR device 112 may correspondingly adjust the presentation style of the hand of the virtual avatar. Furthermore, a predetermined action (e.g., a predetermined gesture) can be configured in association with the function (e.g., presenting a set of controls). In a case where the XR device 112 detects that the action associated with the virtual avatar in the virtual meeting scene is a predetermined action (e.g., the predetermined gesture), operations corresponding to the predetermined action are performed.

It should be understood that the structure and function of the environment 100 are described for illustrative purposes only, without implying any limitation on the scope of the present disclosure.

The following will continue to describe some example embodiments of the present disclosure with reference to the accompanying drawings.

### Example Interaction Flow in the Virtual Scene

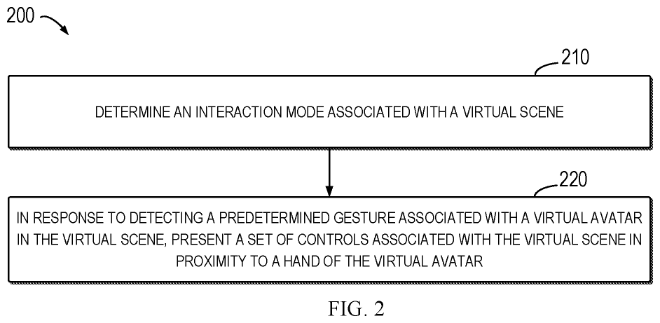

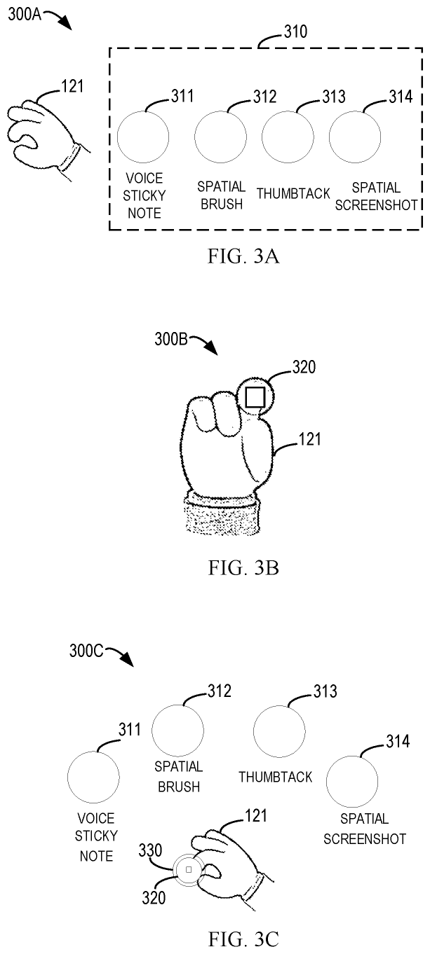

FIG. 2 shows a process 200 for interacting in a virtual scene according to some embodiments of the present disclosure, which can be implemented by the XR device 112. To better illustrate the interaction process of the virtual scene, it will be exemplified with a virtual meeting scene. FIGS. 3A, 3B, and 3C respectively show renderings of examples 300A, 300B, and 300C for interacting in a virtual meeting scene according to some embodiments of the present disclosure. For ease of discussion, the process 200 will be described with reference to at least the environment 100 of FIG. 1, the renderings of example 300A in FIG. 3A, example 300B in FIG. 3B, and example 300C in FIG. 3C.

In block 210, determine an interaction mode associated with a virtual scene. According to embodiments of the present disclosure, the XR device 112 determines the interaction mode of the currently presented virtual scene and such interaction mode may, for example, indicate the current interaction requirements of the virtual scene. For example, in the virtual work scene based on the XR device, such interaction mode may, for example, correspond to different types of work scenes in the virtual work scene, such as meeting scenes, content sharing scenes, screen sharing scenes, etc.

In some embodiments, for example, the interaction mode may also indicate different functional modes in specific scenes. For example, the interaction mode may indicate different meeting modes in the virtual meeting scene, that is, the holding mode of the meeting in the virtual meeting scene, such as “multi-person brainstorming”, “preaching”, “group discussion”, “online seminar”, “night talk around the hearth”, etc. As another example, the interaction mode may also indicate different document editing modes in the document sharing scene: such as, single person editing mode, multi-person collaborative editing mode, etc.

In some embodiments, determining the interaction mode associated with the virtual scene includes: determining the interaction mode associated with the virtual scene based on scene information of the virtual scene. For example, the XR device 112 may determine the current functional mode in the virtual scene as scene information. Such functional modes may, for example, include different meeting modes or different document editing modes discussed above. Alternatively, the XR device 112 may, for example, also determine different application scenes corresponding to the current virtual scene, such as different work scenes, as scene information.

It should be understood that in different virtual scenes, the scene information used to determine the current interaction mode may be different. For example, in the example of determining the meeting mode, the scene information may include information such as the layout of the virtual scene, the number of virtual avatars in the virtual scene, etc. In the scene of determining the document editing mode, the scene information may, for example, include the permissions of the current virtual avatar in the current virtual scene, etc.

In some embodiments, a target interaction mode corresponding to the scene information is determined from a set of predetermined interaction modes associated with the virtual scene. Specifically, the XR device 112 may be associated with a set of predetermined interaction modes for the virtual scene and select an interaction mode to use from a set of predetermined interaction modes based on the determined scene information or specific scene information for the virtual scene used this time. Therefore, the interaction mode corresponding to the current virtual scene may be quickly determined.

Taking the interaction mode which reflects the meeting mode as an example, in some embodiments, the meeting mode may be determined based on the meeting configuration information associated with the virtual meeting scene, and such determining method not only improves the efficiency of determining the meeting mode, but also cause the meeting mode to accurately correspond to the meeting configuration information of the virtual meeting scene, thereby selecting the meeting mode more accurately. For example, the XR device 112 generates the meeting configuration information used by the virtual meeting scene. For example, the user access manner in the virtual meeting scene 120 (for example, which of the devices such as a PC end, mobile end, VR, XR, is used when accessing the virtual meeting,), meeting frequency, speaking permissions of different users, user speaking order, etc. In some embodiments, the meeting configuration information may be set by the organizer of the virtual meeting, and the XR device 112 generates a virtual meeting scene based on the set meeting configuration information correspondingly.

In some embodiments, XR device 112 may determine the meeting mode based on the number of virtual avatars in the virtual meeting scene and the spatial layout of the virtual meeting scene. Such determining method may select a meeting mode that is closer to the interaction pattern of the meeting participant and closer to the user's interaction experience. Specifically, the XR device 112 may determine the above meeting mode based on the number of virtual avatars currently included in the virtual meeting scene and the layout of virtual meeting scene 120. In some embodiments, the spatial layout may include different virtual orientations, positional relationships between virtual avatars, and movable spaces for virtual avatars. For example, the number of virtual avatars included in virtual meeting scene 120 is 3, and the spatial layout of respective virtual avatar is “virtual avatars are within the range of mutual observation” and “virtual avatars may move freely in various spaces in the virtual meeting scene”. Correspondingly, the XR device 112 may determine the meeting mode as “multi-person brainstorming”. For example, the number of virtual avatars in the virtual meeting scene is 50, and the layout of the virtual meeting scene is that the first row only presents a single virtual avatar facing the second to last row. The XR device 112 accordingly determines that the meeting mode associated with the virtual meeting scene is “preaching”.

In some embodiments, the number of virtual avatars may also be determined based on the number of users allowed to join the virtual meeting scene 120, in order to avoid meeting pattern recognition errors due to the continuous entry and exit of meeting participants.

In some embodiments, the XR device 112 may pre-configure the meeting mode corresponding to the numerical range of the number of virtual avatars and the layout in the virtual meeting scene, so as to quickly determine the meeting mode after determining the number of virtual avatars in the virtual meeting scene and the layout of the virtual meeting scene. For example, in a case where the number of virtual avatars is greater than 2 people and less than 12 people, and the layout is that the spatial layout of each virtual avatar is “virtual avatars are within the range of mutual observation”, “virtual avatars can move freely in each space in the virtual meeting scene”, the XR device 112 accordingly determines that the associated meeting mode in the virtual meeting scene is “multi-person brainstorming”.

For example, in a case where the number of virtual avatars is greater than 50, and the layout is “the proportion of the number of virtual avatars facing the same direction to the total number exceeds the first proportion threshold”, and “the number of virtual avatars facing the opposite direction of the same direction falls within the first number interval (for example, the first number interval is [1,10)”, the XR device 112 correspondingly determines the associated meeting mode in the virtual meeting scene as “preaching”.

For example, in a case where the number of virtual avatars is less than 8, and the layout is “no pre-configured position for virtual avatars” and “virtual avatars can move freely in various spaces in the virtual meeting scene”, the associated meeting mode in the virtual meeting scene is determined as “group discussion”.

For example, in a case where the number of virtual avatars is greater than 50 and the layout is “the proportion of the number of virtual avatars facing the same direction to the total number exceeds the first proportion threshold”, “the number of virtual avatars facing the opposite direction of the same direction does not fall within the first number interval”, the XR device 112 correspondingly determines the associated meeting mode in the virtual meeting scene as “online seminar”.

For example, in a case where the number of virtual avatars is greater than 100 and the layout is “virtual avatars can move freely in the space outside the limited area in the virtual meeting scene”, the XR device 112 correspondingly determines the associated meeting mode in the virtual meeting scene as “night talk around the hearth”.

In some embodiments, the meeting mode may also be determined simultaneously based on the meeting configuration information associated with the virtual meeting scene, the number of virtual avatars, and the layout of the virtual meeting scene. For example, in a case where the number of virtual avatars is less than 8 people, the layout is “no pre-configured position for virtual avatars”, “virtual avatars can move freely in various spaces in the virtual meeting scene”, and the meeting frequency is at least 2 times, the associated meeting mode in the virtual meeting scene is determined as “group discussion”.

In some embodiments, regardless of whether the meeting mode is determined solely based on the meeting configuration information or jointly based on the meeting configuration information, as well as the number of virtual avatars and the layout of virtual meeting scenes, a corresponding threshold for the number of conditions may be set. The XR device 112 may determine the meeting mode correspondingly if the number of satisfied conditions exceeds the threshold for the number of conditions. For example, the condition threshold is configured to be greater than or equal to 2 and the corresponding meeting mode “group discussion” is set with a conditions to be met that is the number of virtual avatars being less than 8, the layout being “no pre-configured position for virtual avatars”, “virtual avatars can move freely in various spaces in the virtual meeting scene”, and the meeting frequency being at least 2 times. If the XR device 112 detects that the number of virtual avatars in the meeting scene is less than 8, and the layout is “no pre-configured position for virtual avatars”, the meeting mode can be determined as “group discussion”. It should be understood that the above selection of the value of the condition threshold is only an example and does not constitute any limitation on the present disclosure.

Still referring to FIG. 2, at block 220, in response to detecting a predetermined gesture associated with a virtual avatar in the virtual scene, present a set of controls associated with the virtual scene in proximity to a hand of the virtual avatar, and the set of controls is determined at least based on the interaction mode. In embodiments of the present disclosure, as described above, the XR device 112 may adjust the operation of the virtual avatar (e.g., the hand 121 of the virtual avatar) accordingly based on the operation of the object 113 (e.g., hand) in the physical scene 110 at the XR device 112. The XR device 112 may continuously detect the operation of the virtual avatar and display a set of controls associated with the virtual scene within a predetermined distance range of the hand 121 of the virtual avatar upon detection of a predetermined gesture associated with the virtual avatar.

The user 111 may activate the functions corresponding to the controls by triggering the controls in the virtual scene. For example, in a case where the controls used to implement the “content sharing” function in the virtual scene are activated, that is, the “content sharing” function in the virtual scene is being triggered and used, such a set of controls can be a set of controls associated with the “content sharing” function (such as selecting a document to be delivered, changing a document to be delivered, terminating a document to be delivered, etc.). It should be understood that the interaction mode associated with the virtual scene can change with interaction of the user. For example, after generating the virtual meeting scene, if the user does not use specific controls, the XR device 112 may present a set of controls associated with the virtual meeting scene (such as controls associated with the “content sharing” and “meeting record” functions) to the user. Further, in a case where the user triggers “content sharing”, the XR device 112 may update a set of controls associated with the interaction mode of the virtual meeting scene based on the interaction mode using the “content sharing” function (or present them simultaneously at different locations in the virtual scene, for example, presenting a set of controls associated with “content sharing” in the display area of “content sharing”).

Similarly, for example, a set of controls presented by the XR device 112 in a virtual meeting scene may be determined at least based on the meeting mode, and a set of controls may be configured in the XR device 112 corresponding to the meeting mode. In some embodiments, the XR device 112 selects a target function that may be applied to it from a function library according to the specific meeting mode and encapsulates respective controls of target function into a set of controls.

For example, in the “multi-person brainstorming” meeting mode, the set of controls may include controls for implementing the “voice sticky note”, “spatial brushes”, “thumbtacks”, and “spatial screenshots” functions.

For example, in the “preaching” meeting mode, the set of controls may include controls for implementing the “laser pointer” and “simultaneous translation” functions.

For example, in the “group discussion” meeting mode, the set of controls may include controls for implementing the “laser pointer”, “spatial brush”, and “discussion space” functions.

For example, in the “online seminar” meeting mode, the set of controls may include controls for implementing “simultaneous translation”, “interaction”, and “raising hands” functions.

For example, in the “night talk around the hearth” meeting mode, the set of controls may include controls for implementing “move Position”, “interaction”, and “Emoji Interaction” functions.

Further reference may be made to FIG. 3A, which shows a set of controls 310 in the “multi-person brainstorming” meeting mode, and the set of controls 310 is presented in proximity to the hand 121 of the virtual avatar. The set of controls 310 includes a control 311 that implement the “voice sticky note” function, a control 312 that implement the “spatial brush” function, a control 313 that implement the “thumbtack” function, and a control 314 that implement the “spatial screenshot” function.

In some embodiments, an entrance control 320 may also be correspondingly configured to facilitate the user 111 to invoke the set of controls 310, and to facilitate the XR device 112 to detect whether the actions associated with the virtual avatar in the virtual meeting scene are predetermined gestures. In some embodiments, the XR device 112 may also correspondingly configure a presentation condition of the entrance control 320 for the purpose of determining whether to present the entrance control 320 according to the intention of the user 111. Specifically, as shown in FIG. 3B, the XR device 112 detects that the hand 121 of the virtual avatar is directed toward a predetermined direction (e.g., upward), and the entrance control 320 is presented. Further, as shown in FIG. 3C, after the XR device 112 detects a predetermined gesture of the hand 121 of the virtual avatar for the entrance control 320 (e.g., at least two fingers pinch the entrance control 320), the XR device 112 presents the set of controls 310 adjacent to the hand 121 of the virtual avatar. For example, the XR device 112 presents the controls 311, 312, 313, and 314 included in the set of controls 310 in a circular shape around the entrance control 320.

In some embodiments, the XR device 112 may also determine whether the predetermined gesture is a valid action based on whether the action time of the predetermined gesture exceeds the duration threshold. For example, in a case where the XR device 112 detects that the hand 121 of the virtual avatar has pinched (e.g., pinch of at least two fingers) the entrance control 320 exceeds the duration threshold, the XR device 112 determines that the action of the hand 121 of the virtual avatar to pinch (e.g., pinch of at least two fingers) the entrance control 320 as a valid predetermined gesture. Correspondingly, the XR device 112 may also be associated with the entrance control 320 to present an indication element for prompting. For example, FIG. 3C also includes an indication element 330 associated with the entrance control 320, and in the indication element 330, the presentation style may be adjusted (e.g., gradually fill the geometric shape corresponding to the indication element 330 over time) according to the duration of the hand 121 of the virtual avatar to pinch (e.g., pinch of at least two fingers) the entrance control 320.

In order to reduce the consumption of activating a target control in a set of controls in a virtual meeting scene, and facilitate to send instructions conveniently, the XR device 112 allows users to control the target control to be activated or cease activating the target control through gesture interaction. In some embodiments, in response to detecting a first gesture for a target control in the set of controls, the target control is caused to be activated. Furthermore, in response to detecting a second gesture, the target control is ceased from being activated. Correspondingly, because the presentation effect of controls in the virtual meeting scene often approximates a very thin independent object, the XR device 112 may correspondingly configure gestures that fit the user's interaction habits with objects to activate or cease activating. In some embodiments, the first gesture is a finger pinch gesture, and the second gesture is a finger release gesture. For example, the XR device 112 may detect a finger pinch gesture by detecting whether there is contact between the fingertips and/or finger pulps of at least two fingers in the hand 121 of the virtual avatar. Correspondingly, in a case where the pinch gesture of at least two fingers is detected, the XR device 112 may detect a finger release gesture by detecting whether the fingertips and/or finger pulps of at least two fingers are separated.

Specifically, the XR device 112 may detect gestures to controls associated with virtual avatars in a virtual meeting scene to determine a user intent (e.g., activating controls) of the user (e.g., the user 111) corresponding to the virtual avatar. For convenience of illustration, the control that the user 111 desires to activate is referred to as a target control. Referring to FIG. 4, a schematic diagram of an example of activating a target control in a virtual meeting scene according to some embodiments of the present disclosure is shown. In FIG. 4, the XR device 112 may activate the target control (e.g., the control 314) upon detecting a first gesture (e.g., a pinch of at least two fingers) of the hand 121 of the virtual avatar towards the control 314 in a set of controls 310. In some embodiments, the XR device 112 may also adjust the presentation elements of the target control to identify the target control (e.g., the control 314) activated by the user 111. Further, the XR device 112 may cease activating the target control (e.g., the control 314) upon detecting a second gesture (e.g., release) of the hand 121 of the virtual avatar towards the activated target control (e.g., the control 314)

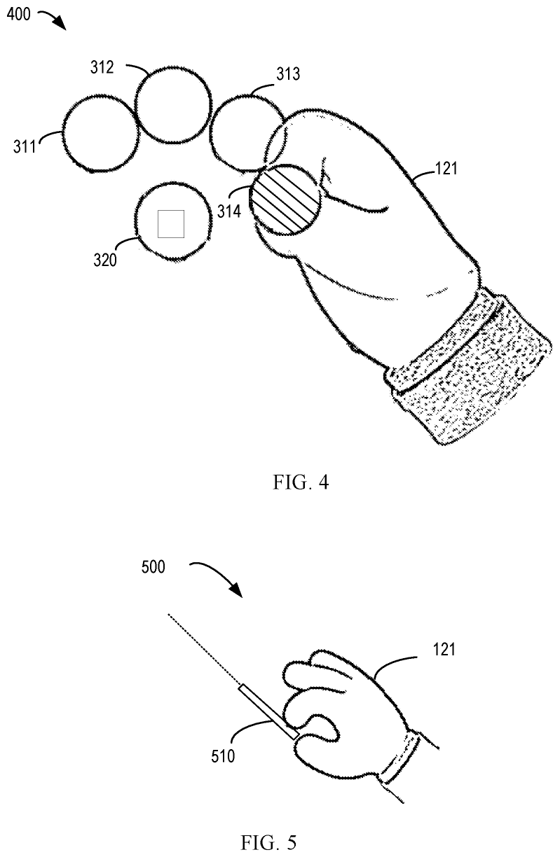

In some embodiments, in a case where the function is activated, a function carrier of the function may also be presented for the convenience of the user correspondingly. For example, FIG. 5 shows a schematic diagram of an example of the function is activated according to some embodiments of the present disclosure. In FIG. 5, the XR device 112 may also add a presentation element 510 of the function carrier corresponding to the hand 121 of the virtual avatar when it is determined that the activated function is a “laser pointer”.

In the case of configuring a set of controls associated with a meeting scene, in order to optimize a control in a set of controls, for example, to increase the probability that respective controls in the set of controls are used, and to reduce the number of controls in the set of controls with less impact on the quality of use of the set of controls. In some embodiments, the method of interacting in a virtual meeting scene further includes: obtaining mode preference information, the mode preference information indicating a frequency of a corresponding control used in different meeting modes. Further, the set of controls is determined based on the mode preference information and the meeting mode. Specifically, the XR device 112 may also obtain mode preference information of the target meeting mode during the process of configuring a set of controls for a specific meeting mode (referred to as the target meeting mode for convenience of illustration), and the mode preference information indicates the frequency of use of the corresponding control in the target meeting mode. For example, when configuring the controls for the meeting mode of “multi-person brainstorming”, the obtained mode preference information is that the control implementing the “voice sticky note” function is used 25 times, the control implementing the “spatial brush” function is used 19 times, the control implementing the “thumbtack” function is used 18 times, the control implementing the “spatial screenshot” function is used 16 times, and the control implementing the “raising hand” function is used 6 times. The XR device 112 may further determine the set of controls based on the frequency of use of respective controls and the meeting mode. In some embodiments, the XR device 112 may determine a valid control at least by determining a control whose frequency exceeds a frequency threshold and/or based on a control with a predetermined order in the frequency ranking result. For example, the XR device 112 determines the control that implements the “voice sticky note” function, the control that implements the “spatial brush” function, the control that implements the “thumbtack” function, and the control that implements the “spatial screenshot” function with a frequency of more than 10 times as valid controls, and encapsulates a set of controls corresponding to the “multi-person brainstorming” meeting mode (for example, the set of controls 310).

In some embodiments, the XR device 112 may also determine a presentation order in the set of controls 310 based on the order of frequency of use, e.g., based on the above-described frequency to determine the presentation order of the control from left to right to which are the control implementing the “voice sticky note” function, the control implementing the “spatial brush” function, the control implementing the “thumbtack” function, and the control implementing the “spatial screenshot” function.

In some embodiments, in a case where the frequency of a control being used is based on a meeting mode previously used in the history, the total number of respective meeting participants using the control may be determined. In some embodiments, in a case where the frequency of a control being used is based on at least two meeting modes previously used in the history, the total number of respective meeting participants using the control may be determined.

In some embodiments, the meeting mode can also be associated with the meeting mode to configure an identity of a meeting participant of respective virtual avatars. For example, in the above-mentioned “preaching” meeting mode, specifically, the XR device 112 may also determine a set of controls based on the identity of the meeting participant corresponding to the virtual avatars. For example, the XR device 112 determines that the identity of the meeting participant of respective virtual avatars “the proportion of the number to the total number exceeds a first proportion threshold”, “virtual avatars facing the same direction” in the layout are “listeners” while the identity of the meeting participant of virtual avatars “facing the opposite direction of the same direction” are “presenters”. Correspondingly, a set of controls is also determined based on the identity of the meeting participant corresponding to the virtual avatars. For example, the XR device 112 may configure a set of controls for virtual avatars with the identity of the meeting participant of “presenters”, including the control that implements the “laser pointer” function, while a set of controls configured for virtual avatars with the identity of the meeting participant of “listeners”, include the control that implements “simultaneous translation”. In this way, a set of controls is correspondingly selected based on the user's participating identity in the meeting process, so that the controls in the set of controls are more in line with the user's actual use scene and improve user experience.

Due to the fact that virtual meeting scenes may be used for interaction among multiple different users, for multi-user virtual meeting scenes, it is necessary to balance the needs of sharing and privacy. In some embodiments, the XR device 112 usually configures two display domains, such as “public domain” and “private domain”. The presentation elements in the “public domain” can be added and associated to all users in the virtual meeting scene for viewing, that is, the display domain visible to all users, while the “private domain” is configured corresponding to the user, and only the corresponding users can view the content presented therein, that is, the presentation elements in the “private domain” can only be viewed by users specific to that “private domain”.

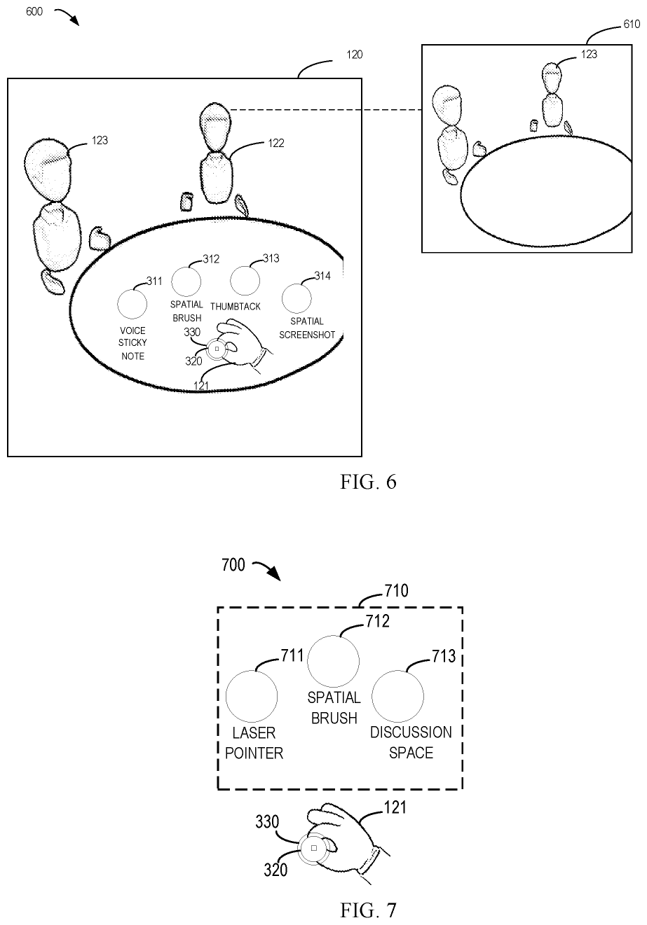

As described above, in order to meet the personalized and privacy needs of users and avoid interference with other users in the virtual meeting scene, a set of controls can be presented only to corresponding users. In some embodiments, a set of controls is only visible to the user corresponding to the virtual avatar, that is, the set of controls is only displayed in the “private domain” of the user corresponding to the virtual avatar. Specifically, when the XR device 112 presents a set of controls, it only presents to the user corresponding to the virtual avatar. For example, when the XR device 112 detects that the set of controls 310 is called out by a predetermined gesture associated with the hand 121 of the virtual avatar (e.g., at least two fingers of the hand 121 of the virtual avatar pinch the entrance control 320), the XR device 112 only presents the set of controls 310 to the user 111. Referring to FIG. 6, FIG. 6 shows a schematic diagram of a presentation example 600 of different users in a virtual meeting scene according to some embodiments of the present disclosure. In FIG. 6, in the virtual meeting scene 120, that is the virtual meeting scene corresponding to the user 111, the XR device 112 only presents the set of controls 310 to the user 111, that is, the user 111 may see the set of controls 310 in the virtual meeting scene 120 (only the controls 311, 312, 313, and 314 included in the set of controls 310 are shown), while in the virtual meeting scene 610 of the virtual avatar 122, the set of controls 310 may not be seen.

Due to the fact that the setting of a set of controls corresponds to the meeting mode, that is, the set of controls often have higher usage value in the corresponding meeting mode, the XR device 112 can also adjust the set of controls accordingly when the meeting mode changes. In this way, the controls in the set of controls can be dynamically and adaptively adjusted according to the changes in the meeting mode, maintaining the usage value of the set of controls presented to the user. In some embodiments, the meeting mode is a first meeting mode, and the set of controls is the first set of controls, and the method further includes: determining that the virtual meeting scene is switched from the first meeting mode to a second meeting mode. Further, in response to detecting the predetermined gesture associated with the virtual avatar, a second set of controls associated with the virtual meeting scene is presented in proximity to the hand of the virtual avatar. In some embodiments, the controls included in the second set of controls differ from those included in the first set of controls in at least one aspect, such as the number of controls, the functions pointed to by the controls, and the presentation order of the controls. For example, the first set of controls includes controls that implement the “laser pointer” and “simultaneous translation” functions, and the second set of controls includes controls that implement the “laser pointer”, “spatial brush”, and “discussion space” functions. In this case, there are differences between the first set of controls and the second set of controls in terms of the number of controls, the functions pointed to by the controls, and the presentation order of the controls. For another example, the first set of controls includes controls that implement the “laser pointer” and “simultaneous translation” functions, and the second set of controls includes controls that implement the “simultaneous translation” and “laser pointer” functions. In this case, there are differences between the first set of controls and the second set of controls in the aspect of presentation order.

As an example, FIG. 7 shows a schematic diagram of an example 700 of meeting mode switch according to some embodiments of the present disclosure. Referring to FIG. 7, in response to determining that the meeting mode is switched from the first meeting mode to the second meeting mode (e.g., switching the “multi-person brainstorming” meeting mode to the “group discussion” meeting mode), the XR device 112 may present the second set of controls 710 (e.g., the second set of controls 710 based on the “group discussion” meeting mode, including the control 711 that implements the “laser pointer”, the control 712 that implements the “spatial brush”, and the control 713 that implements the “discussion space” function) associated with the virtual meeting scene in proximity to the hand 121 of the virtual avatar based on a predetermined gesture associated with the virtual avatar (e.g., at least two fingers of the hand 121 of the virtual avatar pinch the entrance control 320).

According to embodiments of the present disclosure, a set of controls may be configured according to the meeting mode of the virtual meeting scene, to improve the usability of the set of controls, reduce the difficulty and consumption of users selecting a control from the set of controls, and improve user experience.

### Example Apparatus and Device

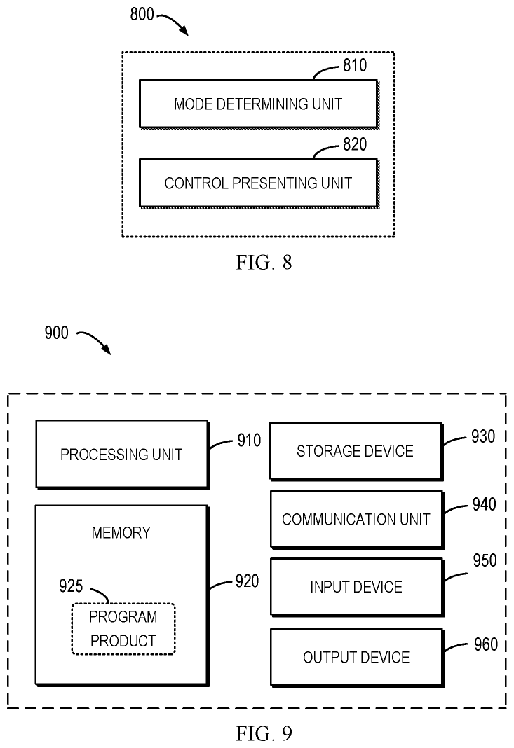

FIG. 8 shows a block diagram of an apparatus 800 for interacting in a virtual meeting scene according to some embodiments of the present disclosure. The apparatus 800 may be implemented as or included in the XR device 112. The various modules/components in the apparatus 800 may be implemented by hardware, software, firmware, or any combination thereof.

As illustrated, the apparatus 800 includes a mode determining unit 810 configured for determining an interaction mode associated with a virtual scene, and a control presenting unit 820 configured for, in response to detecting a predetermined gesture associated with a virtual avatar in the virtual scene, presenting a set of controls associated with the virtual scene in proximity to a hand of the virtual avatar, the set of controls being determined at least based on the interaction mode.

In some embodiments, the determining unit 810 is further configured for determining the interaction mode associated with the virtual scene based on scene information of the virtual scene.

In some embodiments, the determining unit 810 is further configured for determining a target interaction mode corresponding to the scene information from a set of predetermined interaction modes associated with the virtual scene.

In some embodiments, the virtual scene comprises a virtual meeting scene and the interaction mode indicates a meeting mode of the virtual meeting scene.

In some embodiments, the determining unit 810 is further configured for determining the meeting mode based on meeting configuration information associated with the virtual meeting scene or determining the meeting mode based on a number of virtual avatars in the virtual meeting scene and a layout of the virtual meeting scene.

In some embodiments, the apparatus 800 further includes a preference obtaining unit configured for obtaining mode preference information, the mode preference information indicating a frequency of a corresponding control used in different meeting modes, and a control determining unit configured for determining the set of controls based on the mode preference information and the meeting mode.

In some embodiments, in the apparatus 800, the set of controls are further determined based on an identity of a meeting participant corresponding to the virtual avatar.

In some embodiments, in the apparatus 800, the set of controls are only visible to a user corresponding to the virtual avatar.

In some embodiments, the meeting mode is a first meeting mode, the set of controls is a first set of controls, and the apparatus 800 further comprises: a switch determining unit configured for determining that the virtual meeting scene is switched from the first meeting mode to a second meeting mode, and a control switching unit configured for, in response to detecting the predetermined gesture associated with the virtual avatar, presenting a second set of controls associated with the virtual meeting scene in proximity to the hand of the virtual avatar, the second set of controls being different from the first set of controls.

In some embodiments, the apparatus 800 further comprises: an entrance presentation unit configured for in response to detecting the hand of the virtual avatar is directed toward a predetermined direction, presenting an entrance control, and an entrance detecting unit configured for detecting the predetermined gesture for the entrance control.

In some embodiments, the apparatus 800 further includes a control activating unit configured for, in response to detecting a first gesture for a target control in the set of controls, causing the target control to be activated, and a control ceasing unit configured for, in response to detecting a second gesture, ceasing activating the target control.

In some embodiments, in the apparatus 800, the first gesture is a first finger gesture pinching gesture, and the second finger gesture is a finger release gesture.

FIG. 9 shows a block diagram illustrating a computing device 900 in which one or more embodiments of the present disclosure may be implemented. It should be understood that the computing device 900 shown in FIG. 9 is merely an example and should not constitute any limitation on the functionality and scope of the embodiments described herein.

As shown in FIG. 9, the computing device 900 is in the form of a general purpose computing device. Components of the computing device 900 may include, but are not limited to, one or more processors or processing units 910, a memory 920, a storage device 930, one or more communication units 940, one or more input devices 950, and one or more output devices 960. The processing unit 910 may be an actual or virtual processor and is capable of performing various processing according to programs stored in the memory 920. In a multiprocessor system, multiple processing units execute computer-executable instructions in parallel to enhance the parallel processing capability of computing device 900.

The computing device 900 typically includes a variety of computer storage medium. Such medium may be any available medium that is accessible to the computing device 900, including but not limited to volatile and non-volatile medium, removable and non-removable medium. The memory 920 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 930 may be any removable or non-removable medium, and may include a machine-readable medium, such as a flash drive, a disk, or any other medium, which can be used to store information and/or data (such as training data for training) and can be accessed within the computing device 900.

The computing device 900 may further include additional removable/non-removable, volatile/non-volatile storage medium. Although not shown in FIG. 9, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 920 may include a computer program product 925, which has one or more program modules configured to perform various methods or acts of various embodiments of the present disclosure.

The communication unit 940 communicates with a further computing device through the communication medium. In addition, functions of components in the computing device 900 may be implemented by a single computing cluster or multiple computing machines, which can communicate through a communication connection. Therefore, the computing device 900 may be operated in a networking environment using a logical connection with one or more other servers, a network personal computer (PC), or another network node.

The input device 950 may be one or more input devices, such as a mouse, a keyboard, a trackball, etc. The output device 960 may be one or more output devices, such as a display, a speaker, a printer, etc. The computing device 900 may also communicate with one or more external devices (not shown) through the communication unit 940 as required. The external device, such as a storage device, a display device, etc., communicate with one or more devices that enable users to interact with the computing device 900, or communicate with any device (for example, a network card, a modem, etc.) that makes the computing device 900 communicate with one or more other computing devices. Such communication may be executed via an input/output (I/O) interface (not shown).

According to example implementation of the present disclosure, a computer-readable storage medium is provided, on which a computer-executable instruction or computer program is stored, wherein the computer-executable instructions or the computer program is executed by the processor to implement the method described above. According to example implementation of the present disclosure, a computer program product is also provided, and the computer program product is tangibly stored on a non-transitory computer-readable medium and includes computer-executable instructions, which are executed by a processor to implement the method described above.

Various aspects of the present disclosure are described herein with reference to the flow chart and/or the block diagram of the method, the apparatus (system) and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers, or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is exemplary, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

I/We claim:

1. A method of interacting in a virtual scene, comprising:
determining an interaction mode associated with a virtual scene; and
in response to detecting a predetermined gesture associated with a virtual avatar in the virtual scene, presenting a set of controls associated with the virtual scene in proximity to a hand of the virtual avatar, the set of controls being determined at least based on the interaction mode.

2. The method of claim 1, wherein determining the interaction mode associated with the virtual scene comprises:
determining the interaction mode associated with the virtual scene based on scene information of the virtual scene.

3. The method of claim 2, wherein determining the interaction mode associated with the virtual scene based on the scene information of the virtual scene comprises:
determining a target interaction mode corresponding to the scene information from a set of predetermined interaction modes associated with the virtual scene.

4. The method of claim 1, wherein the virtual scene comprises a virtual meeting scene and the interaction mode indicates a meeting mode of the virtual meeting scene.

5. The method of claim 4, wherein determining the meeting mode comprises:
determining the meeting mode based on meeting configuration information associated with the virtual meeting scene; or
determining the meeting mode based on a number of virtual avatars in the virtual meeting scene and a layout of the virtual meeting scene.

6. The method of claim 4, further comprising:
obtaining mode preference information, the mode preference information indicating a frequency of a corresponding control used in different meeting modes; and
determining the set of controls based on the mode preference information and the meeting mode.

7. The method of claim 4, wherein the set of controls are further determined based on an identity of a meeting participant corresponding to the virtual avatar.

8. The method of claim 1, wherein the set of controls are only visible to a user corresponding to the virtual avatar.

9. The method of claim 4, wherein the meeting mode comprises a first meeting mode and the set of controls comprise a first set of controls, the method further comprising:
determining that the virtual meeting scene is switched from the first meeting mode to a second meeting mode; and
in response to detecting the predetermined gesture associated with the virtual avatar, presenting a second set of controls associated with the virtual meeting scene in proximity to the hand of the virtual avatar, the second set of controls being different from the first set of controls.

10. The method of claim 1, further comprising:
in response to detecting the hand of the virtual avatar is directed toward a predetermined direction, presenting an entrance control; and
detecting the predetermined gesture for the entrance control.

11. The method of claim 1, further comprising:
in response to detecting a first gesture for a target control in the set of controls, causing the target control to be activated; and
in response to detecting a second gesture, ceasing activating the target control.

12. The method of claim 11, wherein the first gesture comprises a finger pinch gesture and the second gesture comprises a finger release gesture.

13. An electronic device comprising:
at least one processing unit; and
at least one memory, the at least one memory being coupled to the at least one processing unit and storing an instruction for execution by the at least one processing unit, the instruction, when executed by the at least one processing unit, causing the electronic device to perform acts comprising:
determining an interaction mode associated with a virtual scene; and
in response to detecting a predetermined gesture associated with a virtual avatar in the virtual scene, presenting a set of controls associated with the virtual scene in proximity to a hand of the virtual avatar, the set of controls being determined at least based on the interaction mode.

14. The device of claim 13, wherein determining the interaction mode associated with the virtual scene comprises:
determining the interaction mode associated with the virtual scene based on scene information of the virtual scene.

15. The device of claim 14, wherein determining the interaction mode associated with the virtual scene based on the scene information of the virtual scene comprises:
determining a target interaction mode corresponding to the scene information from a set of predetermined interaction modes associated with the virtual scene.

16. The device of claim 13, wherein the virtual scene comprises a virtual meeting scene and the interaction mode indicates a meeting mode of the virtual meeting scene.

17. The device of claim 16, wherein determining the meeting mode comprises:
determining the meeting mode based on meeting configuration information associated with the virtual meeting scene; or
determining the meeting mode based on a number of virtual avatars in the virtual meeting scene and a layout of the virtual meeting scene.

18. The device of claim 16, the acts further comprising:
obtaining mode preference information, the mode preference information indicating a frequency of a corresponding control used in different meeting modes; and
determining the set of controls based on the mode preference information and the meeting mode.

19. The device of claim 16, wherein the set of controls are further determined based on an identity of a meeting participant corresponding to the virtual avatar.

20. A non-transitory computer readable storage medium, having a computer program stored thereon, the computer program being executable by a processor to implement acts comprising:
determining an interaction mode associated with a virtual scene; and
in response to detecting a predetermined gesture associated with a virtual avatar in the virtual scene, presenting a set of controls associated with the virtual scene in proximity to a hand of the virtual avatar, the set of controls being determined at least based on the interaction mode.
